(19) United States
(12) Patent Application Publication
(10) Pub. No.: US 2002/0029224 A1
(43) Pub. Date: Mar. 7, 2002

(54) Method for transferring information

(76) Inventor: Frederik Carlsson, Lulea (SE)

Correspondence Address: BIRCH STEWART KOLASCH & BIRCH, PO BOX 747, FALLS CHURCH, VA, 22040-0747, US

(21) Appl. No.: 09/846,382

(22) Filed: May 2, 2001

Related U.S. Application Data
(63) Continuation of application No. PCT/SE99/01966, filed on Nov. 1, 1999.

(30) Foreign Application Priority Data
Nov. 2, 1998 (SE) 9803745-0

(51) Int. Cl. G06F 15/16; G01C 21/32; G06F 17/30

(52) U.S. Cl. 707/104.1; 701/209; 707/10; 709/219; 707/200; 709/232

(57) ABSTRACT

A method of updating local map displaying databases of a distributed database via a broadcasting system with a transfer capacity. In a first step it is determined what information the distributed database needs to be updated with. In a second step the information is arranged according to a priority scheme. In a third step the information is transferred to the local map displaying databases via the broadcasting system according to the priority scheme and in dependence of the transfer capacity of the broadcasting system.

### FIELD OF THE INVENTION

The present invention relates generally to a method of information transfer, for example an electronic map, additional information related to an electronic map multimedia applications or the like, in a bandwidth efficient manner with one or more radiofrequency receivers such as mobile, portable, and stationary radiofrequency receivers.

### BACKGROUND TO THE INVENTION

Different map displaying systems, both mobile and stationary, have recently become more and more popular. Same systems provide the user with information pertaining to a geographical region from a database in view of a signal from a GPS receiver. Such a system is described in U.S. Pat. No. 5,767,795. Other map displaying systems comprises storage for various road maps, one of which is selected in view of and overlaid with, traffic information received from specific radio beacon transmitters. Such a system is described in U.S. Pat. No. 5,289,184. Each time the traffic information is received, a fixed timer starts or is restarted in the system, when the timer expires the traffic information is removed. Thus, the traffic information has to be continuously transmitted and received to be displayed.

Further map display systems may be found in JP 10-255022 and EP 786646. The abstract of JP 10-255022 describes a car navigation device that receives map data updates by means of a mobile telephone. EP 786646 describes a vehicle navigation system that may be updated with map data by physically collecting updates in the form of a PC-card from special locations. U.S. Pat. No. 5,684,989 discloses that the updating of information in a local terminal can be carried out at a specified time when the local terminal is idle, but said document relates primarily to the management of database information at the local terminal. It does not disclose or suggest a scheme for managing the transfer of information from the central host to the local terminal.

There seems to be room for improvement in the manner of providing a user in an efficient manner with up to date information that relates to geographical information contained in a mobile, portable or stationary map displaying system.

### SUMMARY OF THE INVENTION

An object of the invention is to define a method for providing an efficient manner of transferring information to one or more information consumers.

Another object of the invention is to define a method which is able to transfer to an information consumer supplemental information relating to primary information contained by the information consumer.

A further object of the invention is to define a method for transferring information to one or more information consumers in an efficient manner without using more bandwidth than necessary of the transferring system.

Still another object of the invention is to define a system for providing supplemental information that relates to geographical information, in an efficient manner to one or more map displaying systems.

Still a further object of the invention is to define a method of providing in an efficient manner a user of a mobile, portable or stationary map displaying system with up to date information that relates to geographical information contained in the map displaying system.

The aforementioned objects are achieved according to the invention by a method of updating local map displaying databases of a distributed database via a transfer system with a transfer capacity. The transfer capacity of the transfer system is limited and can in some cases be relatively small. The method comprises a number of steps. In a first step it is determined what information, preferably additional information, the distributed database needs to be updated with. In a second step the information is arranged according to a priority scheme. In a third step the information is transferred to the local map displaying databases via the transfer system according to the priority scheme and in dependence of the transfer capacity of the transfer system.

The method can advantageously further comprise the step of formatting the information and whereby in the second step of arranging the information according to a priority scheme, the formatting of the information is taken into account. In some versions of the invention the step of formatting the information comprises tagging the information with a start time of availability thereby enabling a local map displaying database to hide the received tagged information until the time of availability. In some versions the step of transferring the information transfers the information ahead of the tagged start time of availability thereby enabling a more even transfer load on the transfer system. Advantageously the step of formatting the information comprises tagging the information with a stop time of availability thereby enabling a local map displaying database to discard the information after the stop time of availability thus saving storage in the local database. Another advantage is that a command for discarding/deleting the information does not have to be transferred thus saving bandwidth. Preferably then also the step of transferring the information does not transfer the information after the tagged stop time of availability or a predetermined time before the tagged stop time of availability thereby avoiding the transfer of obsolete or nearly obsolete information. The step of formatting the information can also advantageously comprise tagging the information with an identification thereby enabling the local map displaying database to determine if the information is already present or not. Preferably the step of transferring the information comprises transferring the information more than one time thereby ensuring to a higher degree that a local map displaying database becomes updated.

The method can preferably also comprise the step of determining to what extent the information should be transferred via the transfer system. The step of transferring the information will then preferably do so in accordance with the step of determining to what extent the information should be transferred, thereby enabling a lower transfer load on the transfer system. To what extent encompasses if the information should be repeatedly transferred or not, and if so how many times, it can also preferably encompass only transferring the information in parts of the transfer system, the information thus not reaching all the local map displaying databases of the distributed database reachable via the transfer system. For example, users located in one city might not be interested in menus of restaurants located in another city far away, it is thus unnecessary to provide these users with the menus.

The information transfer system is advantageously an available broadcasting system such as either an analog type, for example ordinary analog radio such as FM-radio using subcarrier technology to transfer the information, or a digital type, for example digital audio broadcasting (DAB) primarily used for radio or digital video broadcasting (DVB) which is primarily used for TV. The information is advantageously supplemental/additional information that relates to geographical information contained in the map displaying system, the supplemental/additional information being more volatile/changeable than the geographical information contained in the map displaying system.

The aforementioned objects are also achieved by a method of transferring information from an information provider to a map displaying system. The transfer is accomplished by means of a broadcasting system with a transfer capacity to a receiver of the rap displaying system. Thereby an efficient information transfer when a demand to transfer information to the map displaying system is originated by the information provider is enabled. According to the invention the method comprises a number of steps. In a first step the information provider establishes contact with an information transfer point for requesting transfer of information to the map displaying system. In a second step the information transfer point receives the information from the information provider. In a third step the information transfer point formats the received information. In a fourth step the information transfer point arranges the formatted information in a priority scheme based on the formatting. In a fifth step the information transfer point, based on the priority scheme and the transfer capacity of the broadcasting system, transfers the formatted information over the broadcasting system to the receiver of the map displaying system to thereby transfer information from the information provider to the map displaying system in an efficient manner. Advantageously the third step of formatting the received information comprises tagging the information with a start time of availability thereby enabling a map displaying system receiving the information to hide the received tagged information until the time of availability. The fifth step of transferring the formatted information then can preferably transfer the information ahead of the tagged start time of availability thereby enabling a more even transfer load on the broadcasting system.

The third step of formatting the information can advantageously comprise tagging the information with a stop time of availability thereby enabling a map displaying system receiving the tagged information to discard the information after the stop time of availability thus saving storage in the map displaying system. Another advantage is that a command for discarding/deleting the information does not have to be transferred thus saving bandwidth. Preferably then the fifth step of transferring the formatted information does not transfer the information after the tagged stop time of availability or a predetermined time before the tagged stop time of availability thereby avoiding the transfer of obsolete information.

In some versions the third step of formatting the information comprises tagging the information with an identification thereby enabling a map displaying system receiving the tagged information to determine if the information is already present in the system or not. The fifth step of transferring the formatted information can also preferably comprise transferring the information more than one time thereby ensuring to a higher degree that a map displaying system receives the information.

Advantageously the method further comprises the step of determining to what extent the formatted information should be transferred via the broadcasting system. The fifth step of transferring the formatted information will then transfer the information in accordance with the determination to what extent the information should be transferred by determining over which transmitter or transmitters the transfer should take place thereby enabling a lower transfer load on the broadcasting system.

The broadcasting system is preferably of either an analog type, for example ordinary analog radio such as FM-radio using subcarrier technology to transfer the information, or a digital type, for example digital audio broadcasting (DAB) primarily used for radio or digital video broadcasting (DVB) which is primarily used for TV. The information is advantageously supplemental/additional information that relates to geographical information contained in the map displaying system, the supplemental/additional information being more volatile/changeable than the geographical information contained in the map displaying system.

The aforementioned objects are also achieved according to the invention by a method of in a map displaying system receiving information pertaining to the map displaying system via a wireless transfer system. The method comprises a number of steps. In a first step information transferred via the wireless transfer system is received by means of a receiver. In a second step the received information is decoded. In a third step, if the decoded information is tagged with a start time of availability, a comparison of the start time of availability with a current time is performed and it is determined that the information is to be hidden until the current time is equal to or later than the start time of availability. Optionally there is a determination after the second step and before the third step which determines if the information is tagged with a start time of availability. And finally in a fourth step only such information which is not determined to be hidden is made available and possibly displayed.

Advantageously the method further comprises the step of, if the decoded information is tagged with an information identification, determining if stored information with the same identification has been received previously and if it is determined that the same information has been previously received and stored then the currently received information is discarded. Optionally there is a determination before the step which determines if the information is tagged with an information identification.

The method can also advantageously further comprise the step of, if the decoded information is tagged with a stop time of availability, comparing the stop time of availability with a current time and determining that the information is to be discarded when the current time is equal to or later than the stop time of availability. Optionally there is a determination before the step which determines if the information is tagged with a stop time of availability.

Preferably the method further comprises the step of, if the decoded information is a command, then processing the command. Optionally there is a determination before the step which determines if the information is a command.

The wireless transfer system is advantageously an available broadcasting system such as either an analog type, for example ordinary analog radio such as FM-radio using subcarrier technology to transfer the information, or a digital type, for example digital audio broadcasting (DAB) primarily used for radio or digital video broadcasting (DVB) which is primarily used for TV. The information is advantageously supplemental/additional information that relates to geographical information contained in the map displaying system, the supplemental/additional information being more volatile/changeable than the geographical information contained in the map displaying system.

The aforementioned objects are also achieved according to the invention by a map displaying system receiving information pertaining to the map displaying system via a wireless transfer system. According to the invention the map displaying system comprises a receiver, a decoder, a comparator and a display. The receiver receives information transferred via the wireless transfer system. The decoder decodes the received information. The comparator, if the decoded information is tagged with a start time of availability, compares the start time of availability with a current time and determines that the information is to be hidden until the current time is equal to or later than the start time of availability. And the display makes available and displays only such information which is not determined to be hidden.

By providing a method for transferring information from an information provider to an information consumer in the form of a map displaying system via a wireless transfer network, preferably a broadcasting network, a plurality of advantages over prior art systems are obtained. A primary purpose of the invention is to save bandwidth, i.e. allowing a user of a map displaying system to be under the impression that a virtually direct on-line connection exists between the user's local map displaying system and a central database, with only a very limited bandwidth actually being available between the central database and the local map displaying system. According to the invention this is achieved primarily by cutting the peaks (of the desired transmission capacity), i.e. having a continuous fairly low transmission rate instead of having periods with extremely high transmission rates (which transmission rates a system then has to be designed for) with long periods of no transmission at all. This allows the use of transmission systems wish fairly low transmission rates, such as subcarrier transmission (i.e. of the Radio Data System type) in an analog radio broadcasting system, as long as the transmission rate is equal or greater than the average of the necessary transmission rate. A priority scheme of the information will allow this. A further configuration of the invention tags the information to be transmitted with a start time of availability, i.e. a tine before which a user of a map displaying system should not have access to or even be aware of the information. This in combination with map displaying systems that hides the tagged information until time and date is equal to or has passed the start time of availability allows the tagged information to be transmitted at any arbitrary time, preferably but not necessarily before the start time of availability. This will anyway allow the user to believe that the information is received and made available simultaneously. Other types of tags will even further decrease the necessary transmission rate, or allow more information to be transmitted with the same transmission rate. Other advantages of this invention is that obsolete information is automatically removed from the local map displaying systems by means of a stop time of availability tag. In some configurations the information is not transmitted ever the complete broadcasting system but only selected parts which also saves bandwidth.

### BRIEF DESCRIPTION OF THE DRAWINGS

The invention will now be described in more detail for explanatory, and in no sense limiting, purposes, with reference to the following figures, in which

FIGS. 1A-E shows maps of a map displaying system according to the invention,

FIG. 2 shows a block diagram of an information transfer system according to the invention,

FIG. 3 shows a flow chart of a method according to the invention for transmitting additional information,

FIG. 4 shows a flow chart of a method according to the invention for receiving and presenting additional information in a map displaying system according to the invention.

### DESCRIPTION OF PREFERRED EMBODIMENTS

The invention concerns problems associated with information transfer, specifically the transfer of additional/supplemental information to map displaying systems. It is a desire of users of map displaying systems to have access to a continuously updated database. However, it could be considered to be unpractical to be continuously connected to a central database containing all the maps and additional information that one could possibly want to access. One method of providing users/information consumers with easy access to desired maps and still be mobile or portable, i.e. not hooked up to a central database, is to provide each user with his or her own database comprising all the necessary information. However, it could be considered to be a disadvantage that the local database is fixed and that it is difficult to up-date the database by a new database. Users would not have access to volatile information such as road accidents, road construction work, hotel occupancy, meal of the day or menu at different restaurants, the current movies at cinemas, current advertisements and so on.

In a map displaying system according to the invention the information consumers/users have a local database comprising primary information, for example road maps and other types of information that does not change very often. Additionally volatile information, i.e. additional and/or supplemental information of a non-permanent nature, is transferred from one, or more, central databases, information providers, to the users for automatic updating of their local databases. The invention enables this updating of a distributed database in an efficient manner even when the desired information flow/rate temporarily surpasses the instantaneous capacity of the transfer system. According to the invention, information that is to be made available to an information consumer at a predetermined time can be transferred through the transfer system at a for the transfer system suitable time, i.e. when the transfer system has capacity, and be made available to the information consumer first at the predetermined time.

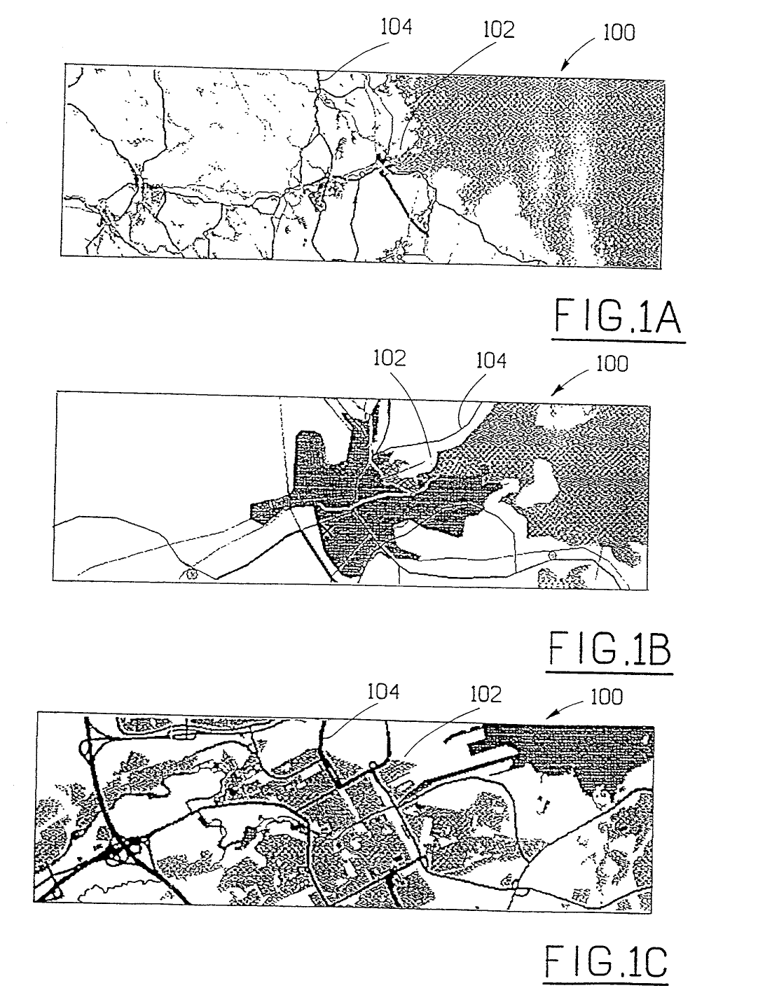

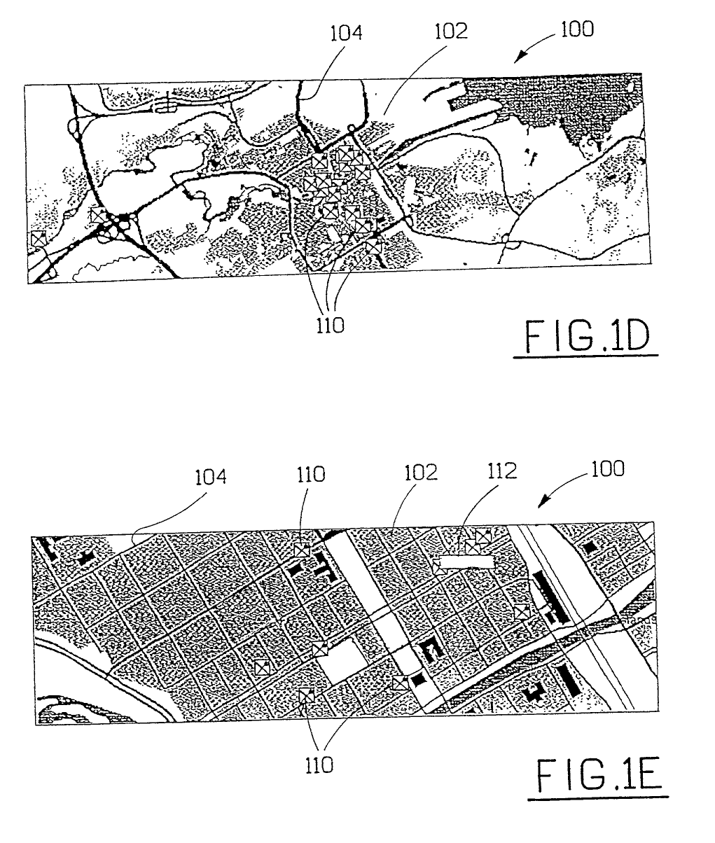

In order to clarify the system according to the invention, some examples of its use will now be described in connection with FIGS. 1A to 4.

FIGS. 1A to 1E show maps of a map displaying system according to the invention with varying degree of magnification and detail. FIG. 1A shows an overview map 100 showing major roads 104 of the central parts of Sweden around the city of Gävle 102. FIGS. 1B and 1C show maps 100 with increasing levels of magnification of the city of Gävle 102 with ever increasing levels of detail of, for example, the roads 104. This is the way a map displaying system according to the invention can be used for, for example, travel guidance. The correct map or displayed area of a map and level of magnification can advantageously be set manually, semi-automatically or completely automatically. The map displaying system according to the invention can optionally be equipped with a GPS receiver. A GPS receiver can provide information of the physical geographical position of the map displaying system which can then display the correct area/map according to that position. This its especially useful in mobile nap displaying systems such as when mounted in a vehicle.

The map displaying system according to the invention further provides additional or supplemental information to travellers or other users. As can be seen in FIG. 1D a user has asked the system to display restaurants 110 onto the map 100, the map otherwise being identical to that of FIG. 1C. FIG. 1E shows a map 100 with even greater magnification with restaurants 110 overlaid. Further additional information in the form of the name 112 of a restaurant is also indicated.

The additional information can also be the menu of the day, opening times, information on reservations etc. when restaurants are concerned. Additional information that is transferred is basically everything that is more volatile/changeable than the infrastructure of for example a city. This can include information on time tables, availability of transportation, road-works/repairs, gas stations, detailed city maps, availability of accommodation, and advertisements. Some of this information is of semi-permanent nature which is valid for months and longer and having no predetermined ending, such as the names and addresses of restaurants. Other information is of a semi-volatile nature perhaps being valid for a predetermined time only ranging from days to months such as specific shows, cinemas and menus. Still other information is of an extremely volatile nature, being valid for a predetermined time of only minutes to perhaps a day or two, such as news flashes or some advertisements, and availability of accommodation. There of course also being other types of information such as being of a volatile nature without an ending time.

According to the invention these different types of information are coded in dependence of their type to put as an even load as possible on the transfer system and also not to put an unreasonable load on the local databases and their available storage facilities. This is possible by a priority scheme that in a temporal manner distributes the transfer of information around the clock, thus allowing the use of a transfer system that has a much lower peak capacity than the expected peak loads of desired information transfer. The priority scheme is based on the urgency, the required availability time, the availability of the information before a demanded availability of the information to the users etc. This can be controlled in some manner by pricing, higher priority information is more expensive to transfer and information that is available a long time before a user must have or is allowed access to the information is cheaper to transfer.

The type of information that a user is allowed to have access to only from a specific time (and date) has traditionally caused problems in transferring such information since it tends to cluster around certain time periods and if all the information was to be transferred at the exact instance the information should be available, then a transfer system with an almost unlimited bandwidth is necessary to provide this service. Fortunately a lot of this type of information is available long before a user is allowed access to it. According to the invention information of this type is coded with a time (and date) when a user will get access to it independently of when the information was transferred. The receiving map displaying system will keep the information in storage and invisible to the user until the time arrives that the user is allowed to have access to the information, first then is it made available to the user accessible parts of the map displaying system. Most information is also advantageously coded with an ending or erasing time (and date) after which it is removed from the local system storage and thus not available any more. Information that is not provided with an ending time can be removed by commands transferred that tell the map displaying system to remove the information. To be able to facilitate the identification and thus processing of the different information blocks, according to the invention each information block is uniquely identified with a unique identification such as a unique number.

The information transfer system is advantageously an available broadcasting system such as an analog (FM) or digital audio or video broadcasting systems (DAB/DVB) which has the ability to transfer information. In an analog broadcasting system, for example FM-radio, information can be transferred by means of subcarrier technology such as that used for radio data system (RDS). However, the advantages of the invention are equally well attained when a point to point transfer system is used.

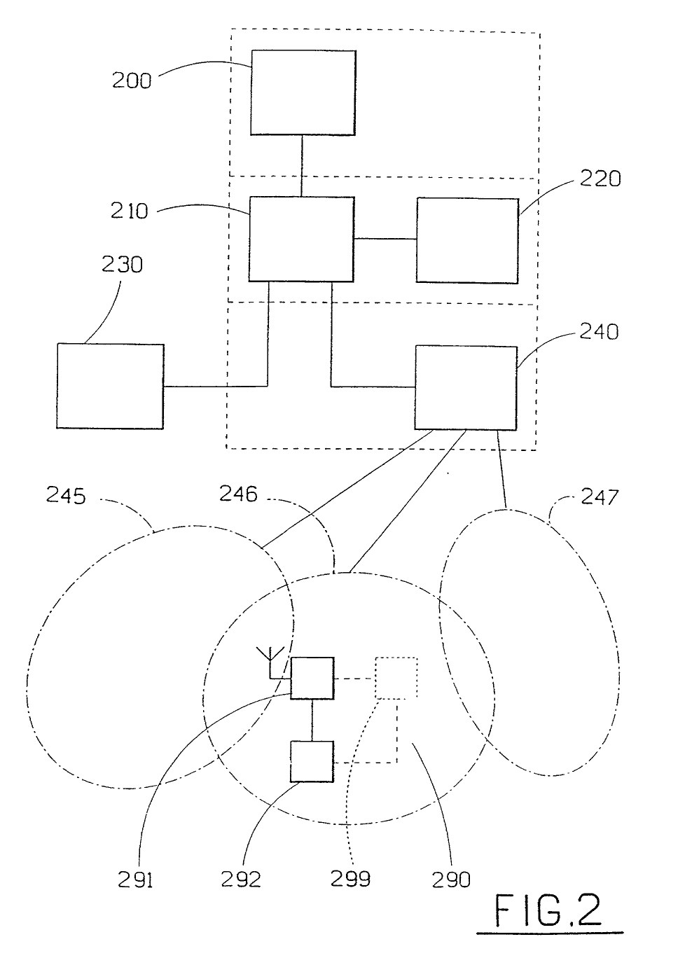

FIG. 2 shows a block diagram of one embodiment of an information transfer system according to the invention. As indicated in the figure and below, certain parts can form smaller or larger groups. The information that is to be transferred to an information consumer/map displaying system 290 can be found at an information/content provider 200. The other parts that make up the system are an information transfer point/a service provider 210 with an associated database 220, a broadcasting network/a network provider 240 with associated transmission cells 245, 246, 247, a further transfer network 230, an information consumer/map displaying system 290 with, for example a FM or a DAB (or other appropriate) receiver 291 and a map display and processing system 292 and optionally moans 299 for receiving/calculating the position of the map displaying system 290, for example by means of a GPS (Global Positioning System) receiver.

The invention is not dependent on the exact physical closeness of the different parts, logically the information consumer 290 is preferably apart from the other parts 200, 210, 220, 230, 240 of the system. For example the information transfer point 210 might be part of the information provider 200, or form part with the information database 220 and the broadcasting network/system 240, or be a completely independent service. As mentioned there are many possibilities, but they do not affect the invention.

Basically the invention provides a map displaying system 290 in an extremely efficient manner with the appearance of being on-line with a central information database. The invention preferably utilizes a broadcasting system 240 for transfer of information to the information consumer 290. A broadcasting system is very effective in transferring information to many receivers. Sometimes a broadcasting system is referred to as a point to multi point transfer system. A customary manner to transfer information to (and from) a single recipient is to use a so called point to point transfer system. A common disadvantage with a point to point system is that it is very expensive per unit of transferred information.

To further lower the transfer load different information can be transferred in the different cells 245, 246, 247. Preferably part of the transferred information is common and part of the information is only transferred in one or more cells or regions 245, 246, 247, i.e. the extent of the transfer can be decided. By charging for the area coverage, some advertisers might feel that it is uneconomical to pay for the transfer of advertisements to, for example, a whole country when the content only has very local interest. A user located in a first region might not be very interested in an advertisement being only of interest in a second region different from the first region. A DAB system can be of a SFN (Single Frequency Network) nature, be of a more traditional radio broadcasting nature with different frequency regions/cells 245, 246, 247 or a combination of both where there can be a SFN covering a nation or large region and also several different DAB frequency regions within the same coverage area, each of which can be a small SFN system. It is possible to direct and send different information within a SFN as well as in the traditional cell structure. Sending different information in a SFN requires great care, but is possible. An analog broadcasting system uses different frequencies in neighboring cells and is thus capable of transmitting different information in different “cells”.

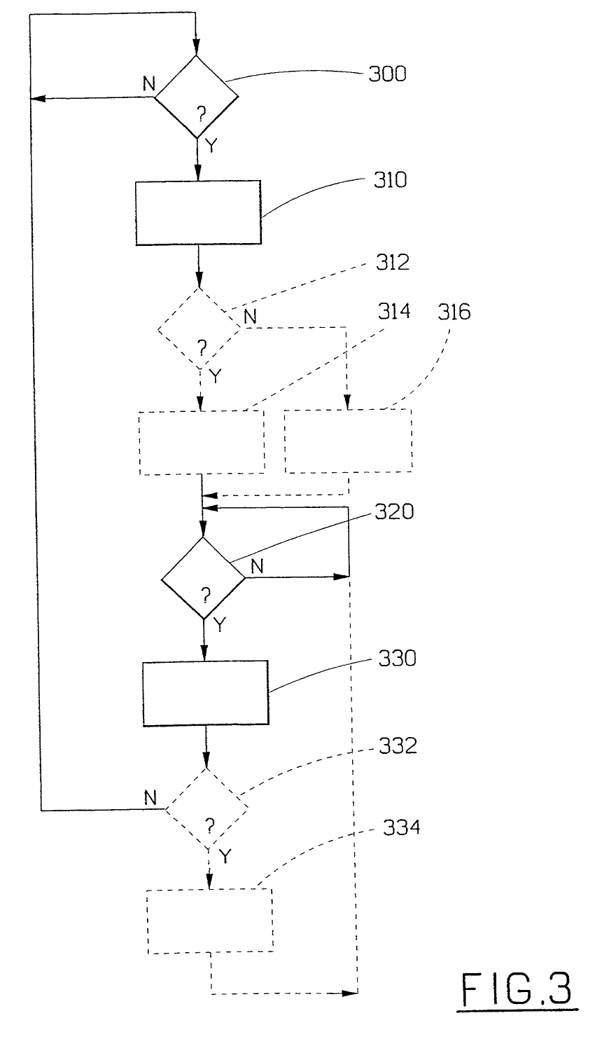

FIG. 3 shows a flow chart of a method according to the invention for transmitting additional information to the information consumers/map displaying system via, for example, a broadcasting system. In a first step 300 it is determined if there is any information to transfer to the local map displaying systems. When there is something to transfer the information in question is coded in a second step 310 with a priority which, for example, can be based on an earliest time of allowable access. The information can advantageously also be coded with an earliest time of allowable access and possibly an end/erase time. Optionally it is determined if the information is to be transferred only in certain regions or in the complete system in first optional step 312. If the information is to be prepared to be transferred in the whole system this is done in a second optional step 314. On the other hand if the extent of the transfer of the information is limited, i.e. the information is only to be transferred in parts of the system then it is prepared for this in a third optional step 316. It is then determined in a third step 320 if there is capacity/bandwidth available in the transfer system in dependence on the set priority. When there is capacity according to the priority the information is transferred in a fourth step 330. The procedure will continue with the first step 300 unless there is a fourth optional step 332 to determine if there should be performed a retransmission of the information or not. If there should be performed a retransmission then preferably there is a delay in a fifth optional step 334 before the procedure continues to the third step 320. If there should not be performed any retransmission of the information, the information is obsolete, or if enough retransmissions have been performed then the procedure advantageously continues with the first step 300.

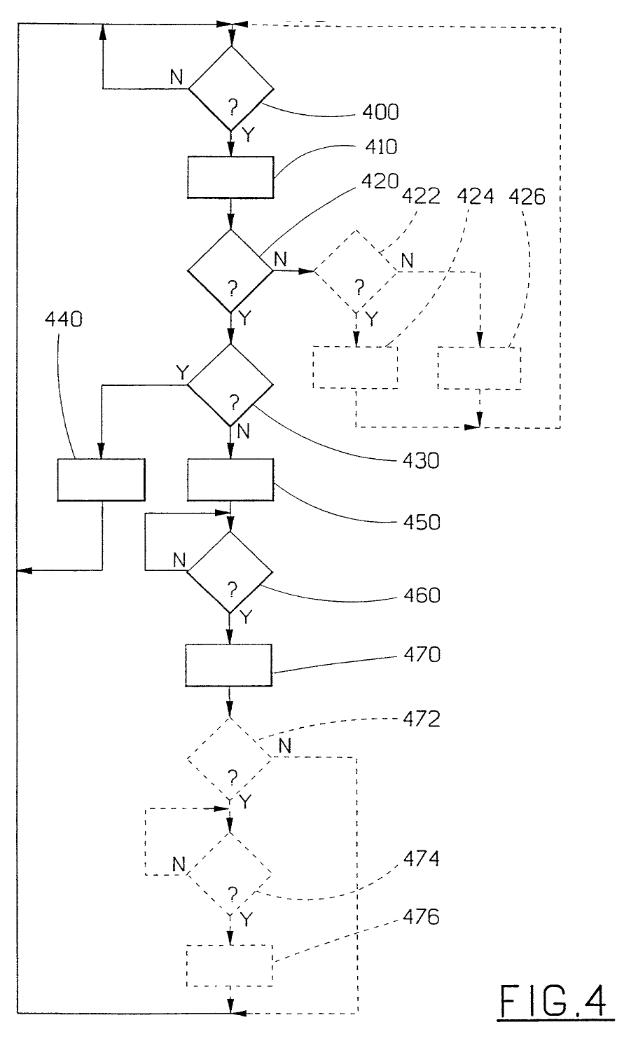

FIG. 4 shows a flow chart of a method according to the invention for receiving and presenting additional information in a map displaying system according to the invention. The procedure stays in a first step 400 until some information has been received. In a second step 410 the received information is decoded. Thereafter in a third step 420 it is determined if the information received is of an additional/supplemental type. If it is not, then in an optional first step it is determined if the information received is a command to, for example, remove a block of information that could be present in the local map displaying system. If it is determined that it is such a remove command then in a second optional step 424 this command is carried out, otherwise in an third optional step 426 some other type of processing is performed on the received information. When the procedure has finished with either the second 424 or third 426 optional steps then the procedure preferably continues with the first step 400 and awaits more information. If it was determined in the third step 420 that the received information was of the additional/supplemental type then the procedure continues in a fourth step 430 that determines if the received block is already received by/present in the map displaying system. This is preferably done by using the unique identification of the information blocks. If it is determined that the received information block is already present, then in a fifth step 440 the received information block is removed from (temporary) storage and the procedure continues to the first step 400. On the other hand if the information block is new to the local map displaying system then in a sixth step 450 the received information block is stored and processed. Thereafter in a seventh step 460, which is preferably a background process, it is determined if the information block in question can be made accessible to a user or not, i.e. has the information been received before the time that the information can be made available to a user, and if the information cannot be made available yet, the procedure remains there until such time arrives when the information can be made available. When the information can be made available, then in an eighth step 470 the information is made visible/available to the user. Thereafter the procedure either enters a fourth optional step 472 or returns to the first step 400 and awaits more information. The fourth optional step 472 determines if the received information block in question has a deactivation time, i.e. a time (and date) when the information block becomes obsolete. If no deactivation time is present with the information block in question the procedure continues with the first step 400 and awaits more information. If a deactivation time is present then, preferably in a background process, a test is made to see if the deactivation time has been reached in a fifth optional step 474 and the procedure remains there until the deactivation tine has been reached. When the deactivation time has been reached, then in a sixth optional step 476 the information block is removed/erased from storage. Thereafter the procedure continues to the first step 400. It should be noted that some of the steps are advantageously performed as background processes and that in some embodiments the whole procedure is performed as a separate, possibly background, process for each received information.

The present invention can be put into apparatus-form either as pure hardware, as pure software or as a combination of hardware and software. If the method according to the invention is realised in the form of software, it can be completely independent or it can be one part of a larger program. The software can suitably be located in a general purpose computer or in a dedicated computer.

As a summary, the invention can basically be described as a method which provides an efficient manner of transferring information to an information consumer.

The invention is not limited to the embodiments described above but may be varied within the scope of the appended patent claims.

FIG. 1

100 Map display

102 City of Gävle

104 Roads

110 Supplemental information A1, Restaurants

112 Supplemental information A2, Detail info of restaurant

FIG. 2

200 requester/information provider

210 information transfer point

220 database

230 other networks

240 Network provider

245 cell 1

246 cell 2

247 cell 3

290 information consumer

291 receiver

292 map display system

299 GPS

FIG. 3

300 Anything to transmit? if no then loop

310 Format information with access time and possibly end/erase time

312 optional: is information to be transferred everywhere?

314 optional: yes, prepare for total transfer

316 optional: no, prepare for selected areas/transfer means

320 is bandwidth/transmission capacity available, possibly in view of priority?

330 transmit/transfer information

332 optional: is information to be retransmitted?

334 optional: if yes then it is suitable with a delay before next transfer/transmission

FIG. 4

400 receive information? if no then loop

410 decode receive information

420 an additional information?

422 optional: is it a command to remove a block of information?

424 optional: if yes, remove designated block

426 optional: other processing of other commands and other types of information

430 is additional information with same block number already received and stored?

440 if yes, then just discard received double

450 if no, then store and process received additional information

460 has activation time been reached? if no then loop

470 if yes, process additional information and make available to information consumer/user

472 optional: is there a deactivation time? if no then exit

474 optional: if yes, has the deactivation time been reached? if no then loop

476 optional: if yes, then remove additional information block and then exit

1. A method of updating local map displaying databases of a distributed database via a transfer system with a transfer capacity, characterized in that the method comprises the following steps in an information transfer point:
determining (300) what information the distributed database needs to be updated with;
arranging the information according to a priority scheme which in a temporal manner distributes the transfer of information;
transferring (330) the information to the local map displaying databases via the transfer system according to the priority scheme and in dependence of the transfer capacity of the transfer system.

2. The method according to claim 1, characterized in that the method further comprises the following step:
formatting (310) the information;
and in that in the step of arranging the information according to a priority scheme, the formatting of the information is taken into account.

3. The method according to claim 2, characterized in that the step of formatting (310) the information comprises tagging the information with a start time of availability thereby enabling a local map displaying database to hide the received tagged information until the time of availability.

4. The method according to claim 3, characterized in that the step of transferring (330) the information transfers the information ahead of the tagged start time of availability thereby enabling a more even transfer load on the transfer system.

5. The method according to any one of claims 2 to 4, characterized in that the step of formatting (310) the information comprises tagging the information with a stop time or availability thereby enabling a local map displaying database to discard the information after the stop time of availability thus saving storage in the local database.

6. The method according to claim 5, characterized in that the step of transferring (330) the information does not transfer the information after the tagged stop time of availability or a predetermined time before the tagged stop time of availability thereby avoiding the transfer of obsolete or nearly obsolete information.

7. The method according to claim 2 characterized in that the step of formatting (310) the information comprises tagging the information with an identification thereby enabling the local map displaying database to determine if the information is already present or not.

8. The method according to claim 1 characterized in that the step of transferring (330) the information comprises transferring the information more than one time thereby ensuring to a higher degree that a local map displaying database becomes updated.

9. The method according to claim 1 characterized in that the method further comprises the following step:
determining (312) to what extent the information should be transferred via the transfer system;
and in that the step of transferring the information does so in accordance with the determining to what extent the information should be transferred, thereby enabling a lower transfer load on the transfer system.

10. The method according to claim 1 characterized in that the transfer system is a broadcasting system.

11. The method according to claim 10, characterized in that the broadcasting system is an analog broadcasting system.

12. The method according to claim 10, characterized in that the broadcasting system is a digital broadcasting system.

13. The method according to claim 1 characterized in that the information is supplemental/additional information that relates to geographical information contained in the map displaying system, the supplemental/additional information being more volatile/changeable than the geographical information contained in the map displaying system.

14. A method of transferring information from an information provider to a map displaying system, by means of a broadcasting system with a transfer capacity to a receiver of the map displaying system, to thereby enable an efficient information transfer when a demand to transfer information to the map displaying system is originated by the information provider, characterized in that the method comprises the following steps:
the information provider establishing contact with an information transfer point for requesting transfer of information to the map displaying system;
the information transfer point receiving the information from the information provider;
the information transfer point formatting (310) the received information;
the information transfer point arranging the formatted information in a priority scheme, that in a temporal manner distributes the transfers based on the formatting;
the information transfer point, based on the priority scheme and the transfer capacity of the broadcasting system, transferring (330) the formatted information over the broadcasting system to the receiver of the map displaying system to thereby transfer information from the information provider to the map displaying system.

15. The method according to claim 14, characterized in that the step of formatting (310) the received information comprises tagging the information with a start time of availability thereby enabling a map displaying system receiving the information to hide the received tagged information until the time of availability.

16. The method according to claim 15, characterized in that the step of transferring (330) the formatted information transfers the information ahead of the tagged start time of availability thereby enabling a more even transfer load on the broadcasting system.

17. The method according to claims 14 to 16, characterized in that the step of formatting (310) the information comprises tagging the information with a stop time of availability thereby enabling a map displaying system receiving the tagged information to discard the information after the stop time of availability thus saving storage in the map displaying system.

18. The method according to claim 17, characterized in that the step of transferring (330) the formatted information does not transfer the information after the tagged stop time of availability or a predetermined time before the tagged stop time of availability thereby avoiding the transfer of obsolete information.

19. The method according to claim 14 characterized in that the step of formatting (310) the information comprises tagging the information with an identification thereby enabling a map displaying system receiving the tagged information to determine if the information is already present in the system or not.

20. The method according to claim 14 characterized in that the step of transferring (330) the formatted information comprises transferring (332, 334) the information more than one time thereby ensuring to a higher degree that a map displaying system receives the information.

21. The method according to claim 14 characterized in that the method further comprises the following step:
determining to what extent (312, 314, 316) the formatted information should be transferred via the broadcasting system;
and in that the step of transferring the formatted information does so in accordance with the determination to what extent the information should be transferred by determining over which transmitter or transmitters the transfer should take place thereby enabling a lower transfer load on the broadcasting system.

22. The method according to claim 14 characterized in that the broadcasting system is an analog broadcasting system.

23. The method according to claim 14 characterized in that the broadcasting system is a digital broadcasting system.

24. The method according to claim 14 characterized in that the information is supplemental/additional information that relates to geographical information contained in the map displaying system, the supplemental/additional information being more volatile/changeable than the geographical information contained in the map displaying system.

25. A method of in a map displaying system receiving information pertaining to the map displaying system via a wireless transfer system, characterized in that the method comprises the following steps:
receiving (400) information transferred via the wireless transfer system by means of a receiver;
decoding (410) the received information;
if the decoded information is tagged with a start time of availability, then comparing (460) the start time of availability with a current time and determining that the information is to be hidden until the current time is equal to or later than the start time of availability;
making available and displaying (470) only such information which is not determined to be hidden.

26. The method according to claim 25, characterized in that the method further comprises the following step:
if the decoded information is tagged with an information identification, then determining (430, 440, 450) if stored information with the same identification has been received previously and if it is determined that the same information has been previously received and stored then the currently received information is discarded.

27. The method according to any one of claims 25 to 26, characterized in that the method further comprises the following step:
if the decoded information is tagged with a stop time of availability, then comparing (474) the stop time of availability with a current time and determining (476) that the information is to be discarded when the current time is equal to or later than the stop time of availability.

28. The method according to claim 25 characterized in that the method further comprises the following step:
if the decoded information is a command, then processing the command.

29. The method according to claim 25 characterized in that the broadcasting system is an analog broadcasting system.

30. The method according to claim 25 characterized in that the broadcasting system is a digital broadcasting system.

31. The method according to claim 25 characterized in that the information is supplemental/additional information that relates to geographical information contained in the map displaying system, the supplemental/additional information being more volatile/changeable than the geographical information contained in the map displaying system.

32. A map displaying system (292) receiving information pertaining to the map displaying system via a wireless transfer system, characterized in that the map displaying system comprises:
a receiver (291) for receiving information transferred via the wireless transfer system;
a decoder (292) for decoding the received information;
a comparator (292) which if the decoded information is tagged with a start time of availability, compares the start time of availability with a current time and determines that the information is to be hidden until the current time is equal to or later than the start time of availability;
a display (100) which makes available and displays only such information which is not determined to be hidden.
